(19) United States
(12) Patent Application Publication
(10) Pub. No.: US 2012/0265679 A1
(43) Pub. Date: Oct. 18, 2012

(54) AUTOMATED TELLER MACHINE (ATM) TO MOBILE COMMUNICATION DEVICE SESSION INTEGRATION

(75) Inventors: Matthew A. Calman, Charlotte, NC (US); Carrie Anne Hanson, Charlotte, NC (US)

(73) Assignee: BANK OF AMERICA CORPORATION, Charlotte, NC (US)

(21) Appl. No.: 13/088,180

(22) Filed: Apr. 15, 2011

(51) Int. Cl. G06Q 40/00; G06F 15/16

(52) U.S. Cl. 705/43; 709/227; 709/206

(57) ABSTRACT

Embodiments of the invention provide for seamless transferring of a user interaction session initiated at an ATM to a customer's mobile communication device. By transferring the user interaction session to the customer's mobile communication device, the customer limits their time interacting with the ATM and, thus, frees up the ATM for any other waiting customers. Additionally, the embodiments provide for a highly secure means of transferring the user interaction session from the ATM to the customer's mobile communication device. For example, Near Field Communication (NFC) or the like may be implemented as the communication mechanism, such that the customer is not required to re-authenticate when the interaction session is presented on the mobile communication device.

### FIELD

In general, embodiments of the invention relate to financial institution interactions and, more particularly, to seamless transferring of a user's Automated Teller Machine (ATM) interaction session to a mobile communication device without the need to re-authenticate the user.

### BACKGROUND

Automated Teller Machines (ATMs) have become the predominant banking channel for the vast majority of customer transactions, especially cash withdrawals, cash/checking deposits or account balance inquiries. While these types of transactions can typically occur at the ATM in a relatively short period of time, other types of transactions and/or activities may occur at the ATM which tend to be longer in duration. Such transactions/activities may include but are not limited to bill-pay transactions, account transfers, product/account enrollment activities and the like. If the customer desires to pursue a lengthy transaction at an ATM, all too often it is to the detriment of other customers waiting to use the ATM.

Moreover, transactions/activities at an ATM may be restricted in scope because most conventional ATMs are limited to a numeric keypad, as opposed to a full keyboard having both alpha and numeric keys. If the transactions/activity being conducted at the ATM warrants alpha inputs, the customer may be posed with unfamiliar keying functions or may have to conduct the transaction/activity at a different banking channel at a later point in time. In the instance in which the customer is faced with unfamiliar keying functions, further delayed may be added to an already time-consuming transactions/activity.

Therefore, a need exists to conduct ATM transactions/activities in a timely fashion so as limit the customer's interaction with the ATM. As such, a need exists, to initiate transactions/activities, specifically time-consuming transactions/activities, at an ATM and to transfer the transaction/activity to another banking channel, such that the transaction/activity may be completed at the other channel. Moreover, the transfer of the transactions/activity should provide the customer the opportunity to seamlessly complete the transaction/activity proximate in time to interfacing with the ATM. Such proximity in time to interfacing with the ATM, insures that the transaction/activity is fresh in the mind of the customer, such that the customer may pick-up the transaction/activity from the place where they left off at the ATM. In addition, by providing the opportunity to complete the transaction/activity proximate in time to interfacing with the ATM assures that the customer does not forget about the transaction or lose interest in the activity. In addition to proximity in time to the ATM interaction, the transfer of the ATM transaction/activity to another banking channel must occur in a secure manner, so as to insure that information related to the transaction/activity is not susceptible to being intercepted by a hacker or other nefarious entity.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, further details are provided below for methods, apparatus and computer-program products that provide for seamless transferring of a user interaction session (i.e., any customer interaction, including transactions, activities, enrollments, experiences, or the like) from an ATM to a customer's mobile communication device. By transferring the user interaction session to the customer's mobile communication device, the customer limits their time interacting with the ATM and, thus, frees up the ATM for any other waiting customers. In addition, the mobile communication device may provide for other benefits not afforded by a conventional ATM, such as, but not necessarily limited to, access to full keyboard and the mobility for the customer to move to a more private area to complete the user interaction session.

Additionally, the embodiments herein disclosed provide for a highly secure means of transferring the user interaction session from the ATM to the customer's mobile communication device. For example, Near Field Communication (NFC) or the like may be implemented as the communication mechanism, such that the customer is not required to re-authenticate when the interaction session is presented on the mobile communication device. By not requiring that the customer re-authenticate the session, the transfer can occur seamlessly and without interruption, thereby, in effect, encouraging the customer to transfer the session from the ATM to the wireless device.

In addition, by providing for transfer to a banking channel (i.e., the mobile communication device) that is in possession of the customer at the time of the ATM interaction, the session can continued close in proximity to when the transfer of the session occurs. Such, instantaneous transfer of the interaction session assures that the customer is mindful of the interaction session after the transfer and is apt to continue/complete the interaction session.

A method defines first embodiments of the invention. The method includes initiating a user interaction session at an Automated Teller Machine (ATM) and transferring the user interaction session from the ATM to a user's mobile communication device. The transferred user interaction session is configured to continue on the mobile communication device absent the user re-authenticating. The user interaction session may include any activity conducted by the customer on the ATM, such as, but not limited to, a bill-pay transaction, a transfer transaction, an investment transaction or inquiry, a product/account enrollment activity, a video chat with financial institution personnel or the like.

In specific embodiments of the method, transferring further includes transferring the user interaction session from the ATM to the user's mobile communication device by implementation of Near Field Communication (NFC). In such embodiments of the method, NFC may be implemented to communicate a Uniform Resource Locator (URL) that provides network access to user interaction session. In such embodiments of the method, the URL may be automatically activated upon receipt by the mobile communication device to continue the user interaction session. In other embodiment s of the method, the URL may be launched at the discretion of the customer, such that the user interaction session may be continued at a later point in time. In alternate embodiments of the method, NFC may be implemented to communicate a NFC signal operable to automatically launch a mobile banking application on the mobile communication device, which serves to continue the user interaction session. Moreover, in such embodiments, NFC may be implemented to communicate the user authentication credentials (e.g., user ID/name and password/passcode) that were used to initiate the user interaction session at the ATM.

In other specific embodiments of the method, transferring further includes transferring the user interaction session from the ATM to the user's mobile communication device by implementation of Short Message Service (SMS) (i.e., text messaging), electronic mail (i.e., email) or the like. In such embodiments of the method, an SMS message, email or the like that includes a Uniform Resource Locator (URL) that provides network access to user interaction session may be communicated from the ATM to the wireless communication device.

In still other specific embodiments of the method, the transfer of the user interaction session may be initiated by receiving, at the ATM, a transfer input, such as in response to a customer being asked if they desire to transfer the interaction session to their mobile communication device. In other related embodiments of the method, the transfer of the user interaction session may be initiated by communicating, from the mobile communication device to the ATM, a transfer request configured to transfer the user interaction session from the ATM to the mobile communication device. In such embodiments, the transfer request may be communicated wirelessly via any known or future known wireless communication mechanism.

In still further embodiments the method may include continuing the user interaction session on the mobile communication device proximate to a point at which the session was occurring on the ATM just prior to transferring. While in still further embodiments of the method, the user interaction session or access to the user interaction session may be stored on the mobile communication device, such that the user interaction session may be continued on the mobile communication device at a later point in time.

A system provides for second embodiments of the invention. The system includes an Automated Teller Machine (ATM) including a first computing platform having a first memory and a first processor in communication with the first memory. The first processor is configured to initiate a user interaction session and provide for transfer of a user interaction session. The system additionally includes a mobile communication device including a second computing platform having a second memory and a second processor in communication with the second memory. The second processor is configured to receive the transfer of the user interaction session from the ATM. The user interaction session is configured to continue on the mobile communication device absent the user re-authenticating. The user interaction session may include any activity conducted by the customer on the ATM, such as, but not limited to, a bill-pay transaction, a transfer transaction, an investment transaction or inquiry, a product/account enrollment activity, a video chat with financial institution personnel or the like.

In specific embodiments of the system the ATM further includes a Near Field Communication (NFC) module and the mobile communication device further includes an NFC component. In such embodiments, Near Field Communication (NFC) is implemented to transfer the user interaction session from the ATM to the mobile communication device. In further related embodiments, the NFC module is configured to communicate, to the NFC component, a Uniform Resource Locator (URL) associated with the user interaction session, such that activation of the URL provides for continuation of the user interaction session. In still further related embodiments, the mobile communication device includes a mobile banking application stored in the second memory and the NFC module is configured to communicate, to the NFC component, an NFC signal operable to automatically launch the mobile banking application, such that launching of the mobile banking application provides for continuation of the user interaction session. Moreover, in other related embodiments of the system, the NFC module is configured to communicate, to the NFC component, user authentication credentials (e.g., user id/name and password/passcode) used to authenticate the user at the ATM.

In other embodiments of the system, the ATM further includes, or is in communication with, a SMS module and the mobile communication device further includes an SMS application such that SMS messaging is implemented to transfer the user interaction session from the ATM to the mobile communication device. In such embodiments, the SMS module may be configured to communicate, to the SMS application, an SMS message including a Uniform Resource Locator (URL) associated with the user interaction session, such that activation of the URL provides for continuation of the user interaction session.

In still further embodiments of the system, the first processor of the ATM is further configured to initiate the transfer of the user interaction session by receiving a transfer input that is operable to transfer the user interaction session from the ATM to the mobile communication device. In other related embodiments of the system, the second processor of the mobile communication device is further configured to initiate the transfer of the user interaction session by communicating a transfer request configured to transfer the user interaction session from the ATM to the mobile communication device. In such embodiments, the transfer request may be communicated wirelessly via any known or future known wireless communication mechanism.

In other related embodiments of the system, the second processor of the mobile communication device is configured to continue the user interaction session on the mobile communication device proximate to a point at which the session was occurring on the ATM just prior to transferring.

A computer program product including a non-transitory computer-readable medium defines third embodiments of the invention. The computer-readable medium includes a first set of codes for causing a computer to initiate a user interaction session at an Automated Teller Machine (ATM) and a second set of codes for causing a computer to transfer the user interaction session from the ATM to a user's mobile communication device. The transferred user interaction session is configured to continue on the mobile communication device absent the user re-authenticating.

Thus, further details are provided below for methods, apparatus and computer-program products that provide for seamless transferring of a user interaction session from an ATM to a customer's mobile communication device. By transferring the user interaction session to the customer's mobile communication device, the customer limits their time interacting with the ATM and, thus, frees up the ATM for any other waiting customers. Additionally, the embodiments herein disclosed provide for a highly secure means of transferring the user interaction session from the ATM to the customer's mobile communication device. For example, Near Field Communication (NFC) or the like may be implemented as the communication mechanism, such that the customer is not required to re-authenticate when the interaction session is presented on the mobile communication device. By not requiring that the customer re-authenticate the session, the transfer can occur seamlessly and without interruption, thereby, in effect, encouraging the customer to transfer the session from the ATM to the wireless device.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIGS. 1A and 1B are schematic diagrams of a system for transferring a user interaction session from an Automated Teller Machine (ATM) to a user's mobile communication device, in accordance with embodiments of the present invention;

FIG. 2 is a block diagram of a system for transferring a user interaction session from an Automated Teller Machine (ATM) to a user's mobile communication device, in accordance with embodiments of the present invention;

FIG. 3 is a block diagram of a system for communicating a interaction session-related URL from an Automated Teller Machine (ATM) to a user's mobile communication device, in accordance with embodiments of the present invention; and

FIG. 4 is a flow diagram of a method for transferring a user interaction session from an Automated Teller Machine (ATM) to a user's mobile communication device, in accordance with present embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, device, or propagation medium. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, methods, apparatus and computer-program products are described in detail below that provide for seamless transferring of a user interaction session (i.e., any customer interaction, including transactions, activities, enrollments, experiences, or the like) from an ATM to a customer's mobile communication device. An ATM as used herein may include a conventional ATM, a Video Teller Machine (VTM), a kiosk or any other computing device used to conduct financial transactions, activities or the like. The mobile communication device may include a smart phone or any other mobile or handheld device capable receiving and/or transmitting wireless communication.

Additionally, the embodiments herein disclosed provide for a highly secure means of transferring the user interaction session from the ATM to the customer's mobile communication device. For example, Near Field Communication (NFC) or the like may be implemented as the communication mechanism, such that the customer is not required to re-authenticate when the interaction session is presented on the mobile communication device. By not requiring that the customer re-authenticate the session, the transfer can occur seamlessly and without interruption, thereby, in effect, encouraging the customer to transfer the session from the ATM to the wireless device.

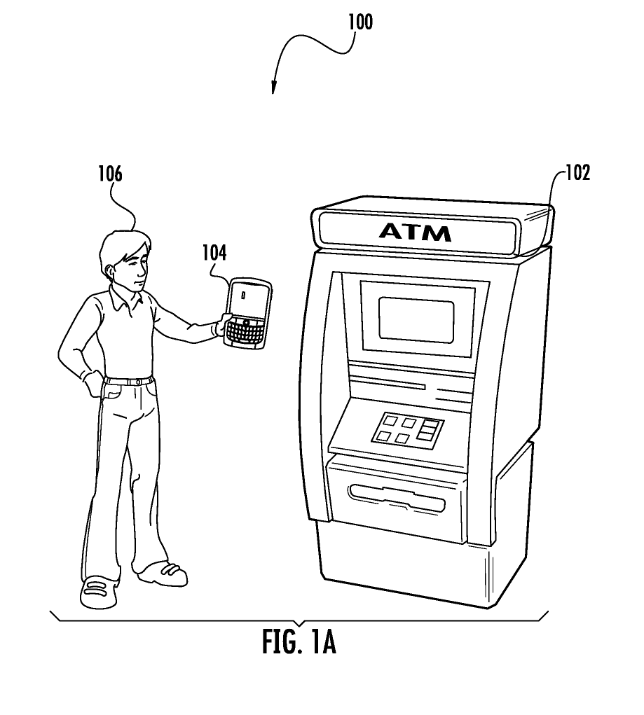

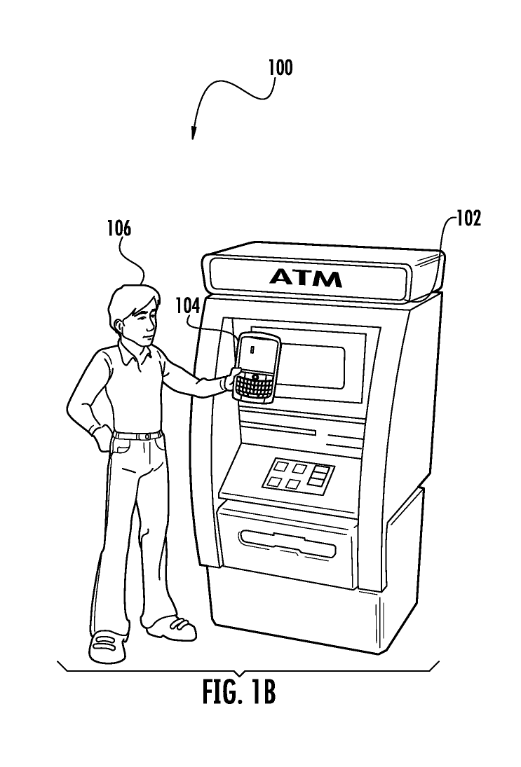

FIGS. 1A and 1B are schematic diagrams of a system 100 for seamlessly transferring a user interaction session from an Automated Teller Machine (ATM) 102 to a mobile communication device 104 in the possession of the user/customer 106 conducting the interaction session, in accordance with embodiments of the present invention. The secure nature of the transfer from the ATM 102 to the user's mobile communication device 104 provides for the interaction session to continue on the mobile communication device 104 without require the user 106 to re-authenticate (i.e., re-enter authentication credentials, such user id/name and passcode, biometric data or the like). The ATM 102 as used and claimed herein includes conventional ATMs, Video Teller Machines (VTMs), kiosks or any other automated computerized system at which a user/customer may conduct an interaction session. In addition, ATM 102 as used and claimed herein is not limited to the components, modules, applications and the like physically embodied in the ATM 102 but also includes the devices, storage/memory, applications, modules and the like that are network accessible to the ATM 102, such as the financial institution network associated with the ATM 102.

The mobile communication device 104 as used herein includes any smart phone, personal digital assistant or any other device configured to receive wireless communication and, specifically wireless communication from the ATM 102. The user interaction session that is transferred from the ATM 102 to the mobile communication device 104 may include any transaction, activity, product/service enrollment, experience or the like that the customer is conducting or participating in on the ATM 102. The ATM 102 may be configured to allow for the transfer of any/all of the interactions/activities conducted on the ATM 102 or, alternatively, the ATM 102 may be configured to allow for the transfer of predetermined interactions/activities (i.e., less than all of the interaction/activities available at the ATM). In those embodiments in which the ATM 102 is configured to allow for transfer of a predetermined number of interactions/activities, the interactions/activities that are deemed worthy of transfer may be those sessions which are typically time-consuming and/or those sessions which would benefit from the customer conducting them in a more private setting than is afforded by the ATM 102.

As illustrated in FIG. 1B, in accordance with specific embodiments of the invention, the user/customer 106 is required to place the mobile communication device 104 in close proximity to a designated region at the ATM 102 or otherwise “tap” the mobile communication 106 to the designated region at the ATM 102 to affect transfer of the interaction session. For example, in those embodiments in which the communication mechanism is Near Field Communication (NFC), discussed in more detail below, or any other communication mechanism that requires the devices to be in very short range (i.e., a few inches or less) to affect communication, the mobile communication device 106 is required to be in close proximity to a designated region on the ATM 102 in order for transfer of the session to occur.

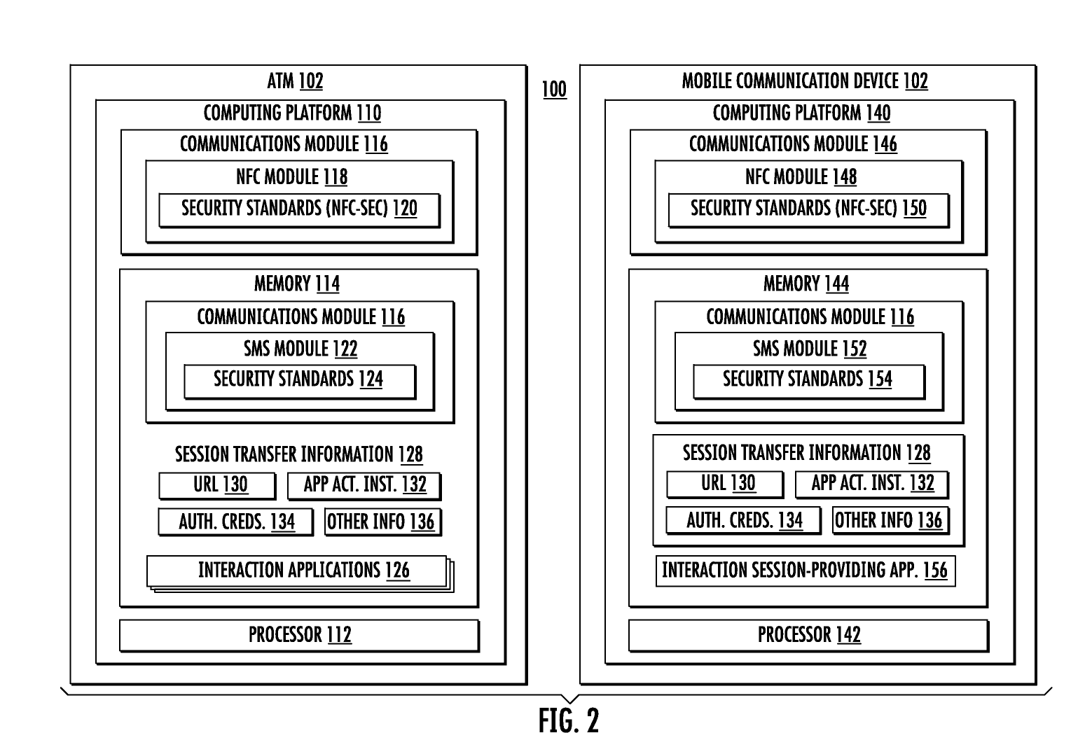

FIG. 2 is a block diagram of a system 100 configured for seamlessly transferring user/customer interaction sessions from an ATM 102 to a mobile communication device 104, in accordance with embodiments of the present invention. The ATM 102 includes a computing platform 110 having at least one processor 112 and a memory 114 in communication with the processor. Memory 114 may be resident on ATM 102 or memory 114 may be remote memory that is network accessible to ATM 102, for example, memory 114 may reside on servers or the like as part of the financial institution's secure network. Memory 114 may comprise volatile and nonvolatile memory such as read-only and/or random-access memory (RAM and ROM), EPROM, EEPROM, or any memory common to computing platforms.

Processor 112 may be an application-specific integrated circuit (“ASIC”), or other chipset, processor, logic circuit, or other data processing device. Processor 112 or other processor such as an Application Specific Integrated Circuit (ASIC) may execute an application programming interface (“API”) layer (not shown in FIG. 2) that interfaces with any resident programs or modules.

Processor 112 may include various processing subsystems (not shown in FIG. 2) embodied in hardware, firmware, software, and combinations thereof, that enable the functionality of ATM 102 and the operability of the ATM 102 on a network, such as a secure financial institution network. For example, processing subsystems allow for initiating and maintaining communications, and exchanging data, with other networked devices. For the disclosed embodiments, processing subsystems of ATM 102 may include any subsystem used in conjunction with applications, modules, components and routines described herein.

In specific embodiments of the invention, the computing platform 110 of ATM 102 includes communication module 116 that is operable to provide secure wireless communication to facilitate the transfer of a user/customer interaction session from the ATM 102 to the mobile communication device 104. In specific embodiments of the invention, the communication module 116 may include Near Field Communication (NFC) Module 118. NFC is a set of short range wireless communication technologies that generally require a distance of 4 centimeters or less. The close range communication that is provided by NFC results in the inability to sniff or otherwise intercept the information associated with the transfer of the user/customer interaction session, such as user/customer authentication credentials, a Uniform Resource Locator (URL) associated with the interaction session or the like.

In addition, NFC module 118 may include security standards 120 that define a protocol stack, such as NFC-SEC or the like, that enables application-independent encryption functions on the data layer, on top of the NFC protocol layer. As such, in addition to providing close range wireless communication, NFC provides for a cryptographically secured protocol, such that session transfer information 128 associated with the transfer of the user/customer interaction session, such as, a Uniform Resource Locator (URL) 130, user/customer authentication credentials 134, session accessing-application activation instructions 132, or other information 136 may be communicated as encrypted data and subsequently decrypted at the mobile communication device 104.

In other embodiments of the invention, communication module 116, or a portion thereof, may be stored in memory 114. In specific such embodiments, communication module 116 may include a Short Message Service (SMS) module 122 that is operable to communicate information to the mobile communication device 104 for the purpose of initiating the transfer of the user/customer interaction session from the ATM 102 to the mobile communication device 104. For example, upon the user/customer providing the requisite input to request a session transfer, a SMS communication (i.e., text message) may be automatically generated and communicated to the mobile communication device 104. In such embodiments the SMS communication may include a session transfer information 128, such as a URL 130 that provides network access to the session, session accessing-application activating instructions 132 (e.g., instructions for activating a mobile banking application) or other information 136. In specific embodiments of the invention, the SMS module 122 may include security standards 124 that define a protocol stack that enables encryption functions on the data layer, on top of the SMS protocol layer. In such embodiments of the invention, the session transfer information 128 included in the communicated SMS message, such as, a URL 130, session accessing-application activating instructions 132, user/customer authentication credentials 134 or other information 136, may be communicated as encrypted data and subsequently decrypted at the mobile communication device 104. In other embodiments, in which the information included in the SMS message is not encrypted or otherwise coded, the transfer process may be configured to provide for the user/customer to mandatorily or optionally re-enter authentication credentials.

Additionally, the memory 114 of ATM 102 includes a plurality of user/customer interaction applications 126, each interaction application 126 is associated with an interaction/activity that the user/customer may conduct on the ATM 102. For example, interaction applications 126 may include, but are not limited to, deposit/withdrawal transactions, investment transactions, account transfers, product/account enrollment, product/account demonstrations, and the like. As previously noted in certain embodiments of the invention, the financial institution or other entity in control of the ATM may configure the interaction applications 126 such that all of applications can be transferred to the mobile communication device 104 or, alternatively, a predetermined portion of the interaction applications 126 may be configured to be transferred to the mobile communication device.

Each of the interaction applications 126 or a designated portion of the interaction applications 126 may include identifiers and/or instructions for the user/customer to recognize the transfer functionality during an interaction session and instructions on how to proceed with implementing the transfer of the interaction session. For example, in those embodiments in which NFC is implemented as the communication mechanism for transfer of the interaction session, the instructions may provide for identifying the “hot spot” on the ATM 102 to which the mobile communication device 104 must be tapped or come into close range proximity in order for the communication/transfer to occur. In other embodiments in which other forms of secure communication are implemented the instructions may provide for the “touch” an identified area of a touch-screen display or enter a designated keystroke on the keypad.

In specific embodiments of the invention, the transfer identifier or instructions may appear within an interaction session if the user/customer has exceeded a predetermined time threshold for completing the interaction session or completely a portion of the interaction session, such that designated portions of the interaction are associated with individual predetermined time thresholds. By providing the transfer identifier or instructions when the user/customer has exceed the time threshold, it may be apparent that the user/customer is taking more time to complete the interaction session or a portion of the session than is typically needed or that the activity, transaction or the like associated interaction session is one that generally takes more time to complete.

The mobile communication device 104 includes a computing platform 140 having at least one processor 142 and a memory 144 in communication with the processor. The mobile communication device 104 includes computing platform 140 that can transmit data across a network, and that can receive and execute routines and applications. Computing platform 140 includes memory 144, which may comprise volatile and nonvolatile memory such as read-only and/or random-access memory (RAM and ROM), EPROM, EEPROM, flash cards, or any memory common to computing platforms. Further, memory 144 may include one or more flash memory cells, or may be any secondary or tertiary storage device, such as magnetic media, optical media, tape, or soft or hard disk.

Further, computing platform 142 also includes processor 142, which may be an application-specific integrated circuit (“ASIC”), or other chipset, processor, logic circuit, or other data processing device. Processor 142 or other processor such as an ASIC may execute an application programming interface (“API”) layer (not shown in FIG. 2) that interfaces with any resident programs stored in the memory 144 of the mobile communication device 104.

Processor 142 includes various processing subsystems (not shown in FIG. 2) embodied in hardware, firmware, software, and combinations thereof, that enable the functionality of mobile communication device 104 and the operability of the mobile communication device 104 on a wireless network. For example, processing subsystems allow for initiating and maintaining communications, and exchanging data, with other networked devices. For the disclosed embodiments, processing subsystems of processor 142 may include any subsystem used in conjunction with the modules, applications, components and the like herein described.

In specific embodiments of the invention, the computing platform 130 of wireless communication device 104 includes communication module 146 that is operable to receive secure wireless communication to facilitate the transfer of an interaction session from the ATM 102 to the mobile communication device 104. In specific embodiments of the invention, the communication module may include Near Field Communication (NFC) module 148. The NFC module 148 is operable, when the mobile communication device 104 is positioned in close proximity to the ATM 102, to receive NFC communication communicated from the ATM 102. The NFC communication includes session transfer information 128 associated with the transfer of the interaction session, such as Uniform Resource Locator (URL) 130, user/customer authentication credentials 134, session accessing-application activation instructions 132, or other information 136.

In addition, NFC module 148 may include security standards 150 that define a protocol stack, such as NFC-SEC or the like, that enables application-independent decryption functions on the data layer, on top of the NFC protocol layer. As such, NFC communicated encrypted information such as session transfer information 128 associated with the transfer of the user/customer interaction session, e.g., a Uniform Resource Locator (URL) 130, session accessing-application activation instructions 132, user/customer authentication credentials 134, or other information 136 may be subjected to decryption prior to implementing the information to access the interaction session.

In other embodiments of the invention, communication module 146, or a portion thereof, may be stored in memory 144. In specific such embodiments, communication module 146 may include a Short Message Service (SMS) module 152 that is operable to receive information communicated from the ATM 102 for the purpose of initiating the transfer of the user/customer interaction session from the ATM 102 to the mobile communication device 104. For example, an SMS message (i.e., text message) may include session transfer information 128, for example, a URL 130 that provides network access to the session, session accessing-application activation instructions 132, user/customer authentication credentials 134, or other information 136. In specific embodiments of the invention, the SMS module 152 may include security standards 154 that that define a protocol stack that enables decryption functions on the data layer, on top of the SMS protocol layer. As such, SMS communicated encrypted information such as information associated with the transfer of the user/customer interaction session, e.g., user/customer authentication credentials, a Uniform Resource Locator (URL) or the like may be subjected to decryption prior to implementing the information to access the interaction session. In other embodiments, in which the information included in the SMS message is not encrypted or otherwise coded, the transfer process may be configured to provide for the user/customer to mandatorily or optionally re-enter authentication credentials.

Additionally, the memory 142 of mobile communication device 104 may include an interaction session-providing application 156, such as mobile banking application, which may automatically be activated based on receipt of the secure communication from the ATM 102, such as an NFC communication, SMS communication or the like, which is configured to include information for automatically activating such an application. In such embodiments of the invention, activation of the interaction session-providing application 156, such as a mobile banking application, may be operable to automatically continue the interaction session on the mobile communication device 104. Additionally, the information included in the secure communication from the ATM 102 may include the user/customer authentication credentials 134 used to initiate the session on the ATM 102, such that the credentials are automatically applied to the transferred session for the purpose of not requiring the user/customer to re-authenticate (i.e., re-enter the authentication credentials) upon launching the interaction session-providing application 156 and continuing the interaction session on the mobile communication device 104. In addition, the information included in the secure communication from the ATM 102 may include an interaction session bookmark that is operable to provide the interaction session-providing application 156 with information related to where the user/customer concluded the interaction session on the ATM 102, so that the interaction session may be continued on the mobile communication device at or proximate to the location in the session at which the user/customer concluded.

In alternate embodiments of the invention, the session transfer information 128 included in the secure communication from the ATM 102 may include a Uniform Resource Locator (URL) 130 that provides a link to the interaction session. In such embodiments, the URL 130 may be activated upon receipt of the secure communication to provide network access to the continuation if the interaction session. In those embodiments in which the secure communication includes a URL 130, the communication may additionally include the user/customer authentication credentials 134 used to initiate the session on the ATM 102, such that the credentials 134 are automatically applied when activating the URL 130 for the purpose of not requiring the user/customer to re-authenticate (i.e., re-enter the authentication credentials) upon activating the URL 130 and continuing the interaction session on the mobile communication device 104.

Additionally, while in many instances the user/customer may desire to continue the interaction session on the mobile communication device 104 relatively contiguously with conclusion of the interaction session on the ATM 102; however, in other instances the user/customer may desire to continue the interaction session at a later point in time. In such instances, the interaction session transfer process may be configured to store the URL 132 or other session transferring information 128, on the mobile communication device or accessible to the mobile communication device for the purpose of having the user/customer, at their discretion, access and activate the URL 132 or other session transferring information 128 at a later point in time. The system may be configured, by the user/customer or otherwise, such that storage of the URL 132 or other session transfer information 128 is automatic upon receipt, such that the user/customer is required to provide an input to access the transferred interaction session, or the system may be configured to store the URL 132 or other session transfer information 128 based on user/customer request.

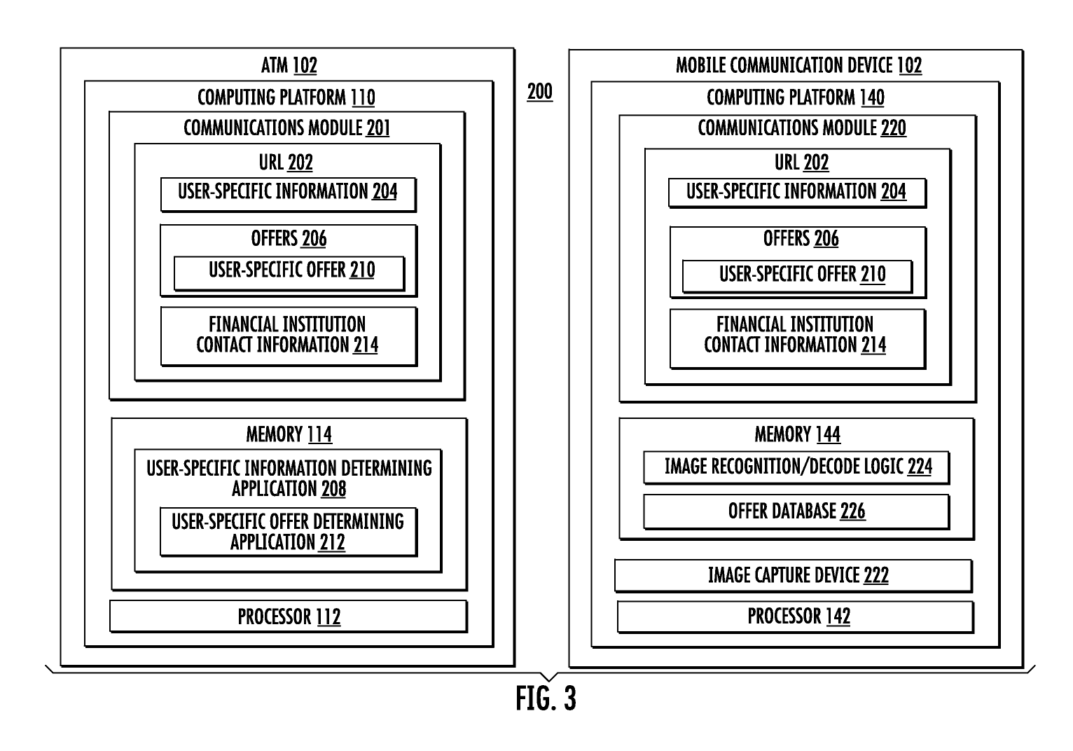

Referring to FIG. 3 a block diagram is depicted of a system 200 configured for communicating, from an ATM 102 to a mobile communication device 104, a Uniform Resource Locator (URL) that provides access to information associated with user interaction session implemented at the ATM 102, in accordance with embodiments of the present invention. The ATM 102 and mobile communication device 104 are similar to those shown and described in relation to FIG. 2. The ATM 102 includes a computing platform 110 having at least one processor 112 and a memory 114 in communication with the processor 112, similarly the mobile communication device 104 includes a computing platform 140 having at least one processor 142 and a memory 144 in communication with the processor 142. Specifics concerning the processors 112 and 142 and the memory 114 and 144 are described above with respect to the discussion if FIG. 2.

In specific embodiments of the invention, the computing platform 110 of ATM 102 includes communication module 201 that is operable to communicate a URL 202 associated with the user interaction session implemented on the ATM 102. Since the information communicated from the ATM 102 to the mobile communication device is not generally considered private information, which would necessitate secure communication, the wireless communication means implemented by the communication module may include any known or future known communication mechanism. For example, the communication module may implement NFC, Bluetooth®, zigbee, RFID, 802.11/Wireless Local Area Network (WLAN) communication or the like. In addition, communication module 201 may implement a visually readable code, such as bar code, Quick Response (QR) code, Secure Quick Response (SQR) code or the like, as the means by which the URL 202 is communicated to the mobile communication device 104. In such embodiments of the system 100, the visually readable code is presented on a display (not shown in FIG. 3) of the ATM 102; in addition, the mobile communication device, equipped with an image capturing mechanism, such as a still image camera or video camera, captures the image and decodes the image to result in the URL.

In specific embodiments of the invention, the URL 202 that is communicated from the ATM 102 to the mobile communication device provides network access of user/customer-specific information 204. In such embodiments of the invention, the memory 114 of ATM 102 includes user-specific information determining application 208 that is operable to determine user-specific information 204. The user/customer-specific information determining application 208 may be configured to determine the user-specific information 204 based on user inputs received during the interaction session at the ATM 102. For example, queries may be posed to the user/customer as part of the interaction session, such as queries related to product enrollment or the like or the queries may be unrelated to the interaction session and presented to the user/customer while a transaction is occurring. In other embodiments of the invention, the user/customer-specific information determining application 208 may be configured to determine the user-specific information 204 based on customer profile information including, but not limited to, historical transaction data. Customer profile information resides on financial institution network servers that are accessible to the ATM 102 during the user's interaction session. In such embodiments of the invention, in which user input and/or user profile information is implemented, the user/customer-specific information determining application 20 is configured to determine the user/customer-specific information 204 on the on-the-fly, during the interaction session.

In specific embodiments of the invention, the URL 202 that is generated and communicated from the ATM 102 to the mobile communication device 104 provides network access to offers, coupons, discounts or the like, collectively referred to herein as “offers” 206. The offers 206 may be associated with financial institution products or services or the offers 206 may be associated with third party-entities, such as retailers, service providers or the like, which may associated, affiliated or otherwise in a relationship with the financial institution. In further specific embodiments of the invention, the offers 206 that are accessible via the communicated URL 202 are user-specific offers 208. In such embodiments, the memory 114 of ATM 102 stores user-specific offer determining application 212 configured to generate user-specific offers 208. The user-specific offers 208 may be generated on-the-fly based on user inputs during the interaction session and/or based on customer profile information, including historical transaction data. Historical transaction data provides for identifying purchasing/transaction trends and the like, such that offers may be uniquely tailored to a user/customer based on their respective transaction history. In addition to the transaction history data, the geographic location of the ATM 102 may additionally be used to determine offers 206 for retailers, service providers or the like that are proximate in location to the ATM 102.

In still further specific embodiments of the invention, the URL 118 that is generated and communicated from the ATM 102 to the mobile communication device 104 provides network access to financial institution contact information 214, the contact information 214 may be direct contact in the form of telephone communication, video chat or the like or the contact information 214 may be indirect contact in the form of addresses, telephone numbers or the like provided via web pages or the like. In addition, “contact information” 214 as used herein may include answers to questions surrounding the interaction session, such as answers to questions related to a product enrollment or financial transaction. The contact information 214 may affirmatively be requested by the user/consumer during or shortly after the user interaction session or in alternate embodiments the contact information, such as a live video/audio chat or the like, may be suggested to the user/customer based inputs received and/or the time consumed in performing a session or a portion of the session.

The computing platform 130 of mobile communication device 102 includes communication module 220 that is operable to receive a URL 202 associated with the user interaction session implemented on the ATM 102. The communication module 220 is configured to implement a communication mechanism that is aligned with the communication mechanism implemented by the ATM 102. For example, the communication module may implement NFC, Bluetooth®, zigbee, RFID, 802.11/Wireless Local Area Network (WLAN) communication or the like, if the corresponding communication mechanism is implemented by the ATM 102. In addition, the computing platform 130 may include an image capture device 222 and the memory 144 store requisite image recognition/decode logic 224 in the event the ATM communication module 201 is configured to implement a visually readable coded, such as bar code, Quick Response (QR) code, Secure Quick Response (SQR) code or the like, as the means by which the URL 202 is communicated to the mobile communication device 104.

In those embodiments of the invention in which the communication from the ATM 102 includes a URL 202 associated with an offer 206, upon receipt of the communication by the device 104, the URL 202 may be configured to be automatically activated or user-activated. Activation of the URL 202 is operable to provide network access to the offer 206, such a coupon, discount or the like. Once the offer has been accessed, the user/customer may select the offer to download the offer 206 to an offer database 226 stored in the memory 144 of the mobile communication device 104 or remotely stored and accessible to the mobile communication device 104. Downloading and storing the offer 206 provides for subsequent use of the offer at a later point in time.

In those embodiments of the invention in which the communication from the ATM 102 includes a URL 202 associated with financial institution contact information 214, upon receipt of the communication by the device 104, the URL 202 may be configured to be automatically activated or user activated. Activation of the URL 202 is operable to provide network access to the financial institution contact information 214. For example, if the URL 202 is associated with a contact telephone number, activation of the URL 202 may provide for automatically dialing the telephone number or the mobile communication device 104 for the purpose of initiating a contact telephone call. In another example, if the URL 202 is associated with a video chat session, activation of the URL 202 may provide for automatically dialing the initiating the vide chat with a contact representative on the mobile communication device 104. In a still further example, if the URL 202 is associated with a contact information webpage, activation of the URL 202 may provide for network accessing of the associated webpage/website.

Thus, embodiments of the invention described above provide for seamless transferring of a user interaction session from an ATM to a customer's mobile communication device. Additionally, the embodiments herein disclosed provide for a highly secure means of transferring the user interaction session from the ATM to the customer's mobile communication device. For example, Near Field Communication (NFC) or the like may be implemented as the communication mechanism, such that the customer is not required to re-authenticate when the interaction session is presented on the mobile communication device.

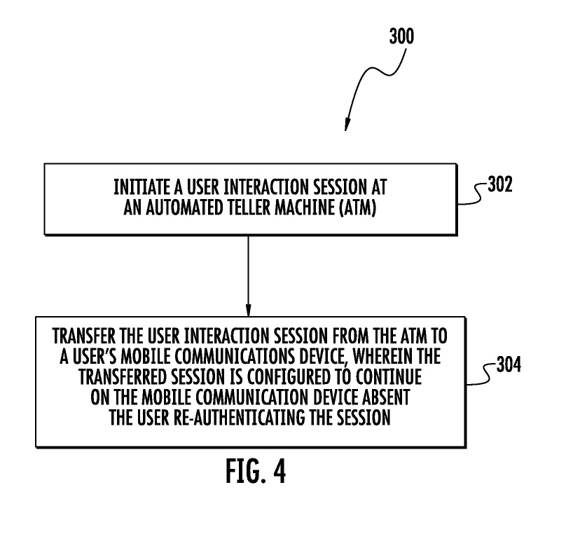

FIG. 4 is a flow diagram of a method 300 for transferring a user interaction session from an Automated Teller Machine (ATM) to a mobile communication device, in accordance with embodiments of the present invention. At Event 302, a user interaction session is initiated at an Automated Teller Machine (ATM). As previously noted, the ATM may include a conventional ATM, a Video Teller Machine (VTM), a kiosk or any other automated computing device configured to provide financial institution transactions, activities, experiences or the like. The user interaction session may include bill-pay transactions, account transfers, investment transactions, product/account enrollments, user experiences, such as video chat session or the like. Initiation of the user interaction session includes a user authentication process whereby the user verifies their identity through input of authentication credentials, such as passcode, biometric data or the like.

At Event 304, the user interaction session is transferred from the ATM to the user's mobile communication device. The transferred user interaction session is configured to continue on the mobile communication device absent the user re-authenticating.

In specific embodiments of the method, transferring of the user interaction session occurs via implementation of Near Field Communication (NFC). In such embodiments, an NFC communication may include a Uniform Resource Locator (URL) that, upon automatic or manual activation, provides network access to the user interaction session, such that the user interaction session may be continued at or proximate with the point at which the session concluded at the ATM. In other specific embodiments, the NFC communication includes instructions for automatically activating a interaction-session activating applications, such as a mobile banking application or the like, such that the mobile banking application provides continuing the user interaction session at or proximate with the point at which the session concluded at the ATM. In additional embodiments, the NFC communication is configured to include the authentication credentials, such that the credentials may be automatically applied to the interaction session at the mobile communication device, to obviate the need for the user to re-enter authentication credentials.

In other specific embodiments of the method, transferring of the user interaction session occurs via implementation of Short Message Service (SMS) communication. In such embodiments, an SMS (i.e., text message) communication may include a Uniform Resource Locator (URL) that, upon automatic or manual activation, provides network access to the user interaction session, such that the user interaction session may be continued at or proximate with the point at which the session concluded at the ATM.

Thus, further details are provided below for methods, apparatus and computer-program products that provide for seamless transferring of a user interaction session from an ATM to a customer's mobile communication device. By transferring the user interaction session to the customer's mobile communication device, the customer limits their time interacting with the ATM and, thus, frees up the ATM for any other waiting customers. Additionally, the embodiments herein disclosed provide for a highly secure means of transferring the user interaction session from the ATM to the customer's mobile communication device. For example, Near Field Communication (NFC) or the like may be implemented as the communication mechanism, such that the customer is not required to re-authenticate when the interaction session is presented on the mobile communication device. By not requiring that the customer re-authenticate the session, the transfer can occur seamlessly and without interruption, thereby, in effect, encouraging the customer to transfer the session from the ATM to the wireless device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method, comprising:
initiating a user interaction session at an Automated Teller Machine (ATM); and
transferring the user interaction session from the ATM to a user's mobile communication device,
wherein the transferred user interaction session is configured to continue on the mobile communication device absent the user re-authenticating.

2. The method of claim 1, wherein transferring further comprises transferring the user interaction session from the ATM to the user's mobile communication device by implementation of Near Field Communication (NFC).

3. The method of claim 2, wherein transferring further comprises communicating, from the ATM to the mobile communication device, a Uniform Resource Locator (URL) associated with the user interaction session and activating the URL to continue the user interaction session.

4. The method of claim 2, wherein transferring further comprises communicating, from the ATM to the mobile communication device, a NFC signal operable to launch a mobile banking application on the mobile communication device and automatically launching the mobile banking application, based on receipt of the NFC signal by the mobile communication device, to continue the user interaction session.

5. The method of claim 2, wherein transferring further comprises communicating, from the ATM to the mobile communication device, user authentication credentials used to authenticate the user at the ATM.

6. The method of claim 1, wherein transferring further comprises transferring the user interaction session from the ATM to the user's mobile communication device by implementation of Short Message Service (SMS).

7. The method of claim 6, wherein transferring further comprises communicating, from the ATM to the mobile communication device, an SMS message that includes a Uniform Resource Locator (URL) associated with the user interaction session.

8. The method of claim 1, wherein the user interaction session further comprises one of a bill-pay transaction, a transfer transaction, or an investment transaction.

9. The method of claim 1, wherein the user interaction session further comprises a product enrollment activity.

10. The method of claim 1, wherein the user interaction session further comprises a video chat session.

11. The method of claim 1, wherein transferring further comprises receiving, at the ATM, a transfer input configured to transfer the user interaction session from the ATM to the mobile communication device.

12. The method of claim 1, wherein transferring further comprises communicating, from the mobile communication device to the ATM, a transfer request configured to transfer the user interaction session from the ATM to the mobile communication device.

13. The method of claim 1, wherein, upon transferring, the user interaction session is continued on the mobile communication device proximate to a point at which the session was occurring on the ATM just prior to transferring.

14. A system, comprising:
an Automated Teller Machine (ATM) including a first computing platform having a first memory and a first processor in communication with the first memory, wherein the first processor is configured to initiate a user interaction session and provide for transfer of an ongoing user interaction session; and
a mobile communication device including a second computing platform having a second memory and a second processor in communication with the second memory, wherein the second processor is configured to receive the transfer of the user interaction session from the ATM and, wherein the session is configured to continue on the mobile communication device absent the user re-authenticating.

15. The system of claim 14, wherein the ATM further includes a Near Field Communication (NFC) module and the mobile communication device further includes an NFC component, such that Near Field Communication (NFC) is implemented to transfer the user interaction session from the ATM to the mobile communication device.

16. The system of claim 15, wherein the NFC module is configured to communicate, to the NFC component, a Uniform Resource Locator (URL) associated with the user interaction session, such that activation of the URL provides for continuation of the user interaction session.

17. The system of claim 15, wherein the mobile communication device includes a mobile banking application stored in the second memory and the NFC module is configured to communicate, to the NFC component, an NFC signal operable to automatically launch the mobile banking application, such that launching of the mobile banking application provides for continuation of the user interaction session.

18. The system of claim 15, wherein the NFC module is configured to communicate, to the NFC component, user authentication credentials used to authenticate the user at the ATM.

19. The system of claim 14, wherein the ATM further includes a SMS module and the mobile communication device further includes an SMS application such that SMS messaging is implemented to transfer the user interaction session from the ATM to the mobile communication device.

20. The system of claim 19, wherein the SMS module is configured to communicate, to the SMS application, an SMS message including a Uniform Resource Locator (URL) associated with the user interaction session, such that activation of the URL provides for continuation of the user interaction session.

21. The system of claim 14, wherein the user interaction session further comprises one of a bill-pay transaction, a transfer transaction, or an investment transaction.

22. The system of claim 14, wherein the user interaction session further comprises a product enrollment activity.

23. The system of claim 14, wherein the user interaction session further comprises a video chat session.

24. The system of claim 14, wherein the first processor of the ATM is further configured to receive a transfer input that is operable to transfer the user interaction session from the ATM to the mobile communication device.

25. The system of claim 14, wherein the second processor of the mobile communication device is further configured to communicate a transfer request that is operable to transfer the user interaction session from the ATM to the mobile communication device.

26. The system of claim 14, wherein the second processor of the mobile communication device is configured to continue the user interaction session on the mobile communication device proximate to a point at which the session was occurring on the ATM just prior to transferring.

27. A computer program product, comprising:
a non-transitory computer-readable medium comprising:
a first set of codes for causing a computer to initiate a user interaction session at an Automated Teller Machine (ATM); and
a second set of codes for causing a computer to transfer the user interaction session from the ATM to a user's mobile communication device,
wherein the transferred user interaction session is configured to continue on the mobile communication device absent the user re-authenticating.

28. The computer program product of claim 27, wherein the second set of codes is further configured to cause the computer to transfer the user interaction session from the ATM to the mobile communication device by implementation of Near Field Communication (NFC).

29. The computer program product of claim 28, wherein the second set of codes is further configured to cause the computer to communicate, from the ATM to the mobile communication device, a Uniform Resource Locator (URL) associated with the user interaction session, such that activating the URL continues the user interaction session.

30. The computer program product of claim 28, wherein the second set of codes is further configured to cause the computer to communicate, from the ATM to the mobile communication device, a NFC signal operable to launch a mobile banking application on the mobile communication device, such that the mobile banking application is automatically launched to continue the user interaction session.

31. The computer program product of claim 28, wherein the second set of codes is further configured to cause the computer to communicate, from the ATM to the mobile communication device, user authentication credentials used to authenticate the user at the ATM.

32. The computer program product of claim 27, wherein the second set of codes is further configured to cause the computer to transfer the user interaction session from the ATM to the mobile communication device by implementation of Short Message Service (SMS).

33. The computer program product of claim 32, wherein the second set of codes is further configured to cause the computer to communicate, from the ATM to the mobile communication device, an SMS message that includes a Uniform Resource Locator (URL) associated with the user interaction session.

34. The computer program product of claim 27, wherein the first set of codes is further configured to initiate the user interaction session, wherein the session further comprises one of a bill-pay transaction, a transfer transaction, or an investment transaction.

35. The computer program product of claim 27, wherein the first set of codes is further configured to initiate the user interaction session, wherein the session further comprises a product enrollment activity.

36. The computer program product of claim 27, wherein the first set of codes is further configured to initiate the user interaction session, wherein the session further comprises a video chat session.

37. The computer program product of claim 27, wherein the second set of codes is further configured to cause the computer to receiving, at the ATM, a transfer input configured to transfer the user interaction session from the ATM to the mobile communication device.

38. The computer program product of claim 27, wherein the second set of codes is further configured to cause the computer to communicate, from the mobile communication device to the ATM, a transfer request configured to transfer the user interaction session from the ATM to the mobile communication device.

39. The computer program product of claim 27, further comprising a third set of codes for causing a computer to continue the user interaction session on the mobile communication device proximate to a point at which the session was occurring on the ATM just prior to transferring.
